(19) United States
(12) Patent Application Publication
(10) Pub. No.: US 2012/0281251 A1
(43) Pub. Date: Nov. 8, 2012

(54) METHOD AND SYSTEM FOR CONFIGURING PRINTER DRIVERS FOR MULTIPLE PRINTING DEVICES

(75) Inventors: David Salgado, Victor, NY (US); Raymond Sabbagh, Harbor City, CA (US); Matthew David Fabrizi, Penfield, NY (US); Gregory Matthew Fruin, Webster, NY (US); Jonathan Allen Edmonds, Silverton, OR (US); James David Legan, Webster, NY (US); Alan Kenneth Robertson, Rochester, NY (US)

(73) Assignee: XEROX CORPORATION, Norwalk, CT (US)

(21) Appl. No.: 13/101,685

(22) Filed: May 5, 2011

(51) Int. Cl. G06K 15/02

(52) U.S. Cl. 358/1.15

(57) ABSTRACT

The disclosure relates to a computerized method and system for implementing a multi-tiered approach to defining printer driver configuration settings. A printer driver configuration management utility allows establishing settings for multiple printer drivers and multiple printing devices with a single multi-tiered configuration file. In a network environment the configuration file is stored in a location accessible by a client prior to utilizing a printer. A single multi-tiered configuration file makes it possible to pre-configure and post-configure multiple printer drivers. Compatible installed printer drivers check for the configuration file and update settings accordingly. Each setting may have rules of behavior such as a default value, enforced default value, value setting lock and disallowance of a value. An alternate value, such as a secondary value, can be deferred to when a primary setting value is not supported for a particular driver.

### BACKGROUND

Disclosed herein are methods for configuring print drivers, and in particular to such methods that establish a set of printer driver feature defaults to be enforced by the printer driver during printing operation.

A user in a printing environment has access to multiple printing devices. The printing devices include, but are not limited to, printer, digital copier, facsimile unit and multi-function machine (scanner/copier/printer). This installation process is often not straightforward and requires the user's knowledge and correct answers to often complex questions during the installation process. Sometime the user has to add and remove the same driver several times to get a correct installation. The installation process provides or facilitates yet another possible point for failure should some of the installations be flawed. To minimize failure and to implement policy directives in an enterprise, System Administrators (SAs) need to manage their users' printing capabilities to these multiple Printing Devices. For example, an SA may want to create a “green” printing environment where all print drivers are defaulted to duplex printing.

System administrators often pre-configure a print driver before installing it on a given print server. Such pre-configuration includes, for example, changing the device default settings to enable/disable features like stapling, duplex printing, color settings, and the like. Pre-configuration generally follows a process that includes generating a configuration file that, for example, is identified by a filename with a “cfg” suffix. The configuration file contains, among other things, device configuration settings. During installation on the print server, the configuration file is read and the settings therein applied to the specific printer driver. A configuration file that is narrowly tailored to the user, a client computer, or a given print server is generally distributed by device manufacturers through computer readable medium or through file repositories maintained by a server.

After distribution and installation of print drivers across an enterprise network, enterprise-wide print driver defaults sometimes need to be changed. This process is known as post-configuration of the print driver. Examples of post-configuration include implementation of corporate policy change that specifies defaults and try to maximize printing resources. In an enterprise with hundreds of computers and printing devices this can be a daunting and laborious task.

For the reasons stated above, and for other reasons stated below which will become apparent to those skilled in the art upon reading and understanding the present specification, there is a need in the art is systems and methods for pre-configuring and post-configuring multiple printer drivers with a single configuration file.

### SUMMARY

According to aspects of the embodiments, there is provided systems and methods for implementing a multi-tiered approach to defining printer driver configuration settings. A printer driver configuration management utility allows system administrators to establish settings for multiple printer drivers and multiple printing devices with a single configuration file. A single multi-tiered configuration file makes it possible to pre-configure and post-configure multiple printer drivers. Compatible installed printer drivers check for the configuration file and update settings based on the applicable rules. Each setting may have rules of behavior such as a default value, enforced default value, value setting lock and disallowance of a value. An alternate value, such as a secondary value, can be deferred to when a primary setting value is not supported for a particular driver. One embodiment hereof utilizes a network based central storage of driver configuration files that can be updated at any time by an administrator. These configuration files are stored at an enterprise accessible location and accessed by client devices prior to utilizing a network accessible printer. In one embodiment, each print server is configured with a specification of the enterprise accessible location that contains the print driver configuration files. Client devices receive a specification of the enterprise accessible location from the print server as part of the printing process.

### BRIEF DESCRIPTION OF THE DRAWINGS

FIG. 1 is an illustration of a networked printing environment in accordance to an embodiment;

FIG. 2 illustrates a block diagram of a controller for a printer system in accordance to an embodiment;

FIG. 3 illustrates a diagram of a print user interface in accordance to an embodiment;

FIG. 4 illustrates the user interface 410 for a print driver configuration tool in accordance to an embodiment;

FIG. 5 illustrates a diagram of a print driver configuration tool properties interface in accordance to an embodiment;

FIG. 6 is an illustration of the format for a print driver configuration rule in accordance to an embodiment;

FIG. 7 illustrates a flowchart of a method to configure a print driver in a computer for multiple printing devices in a network environment in accordance to an environment;

FIG. 8 illustrates a flowchart of a method to create configuration parameter rules in accordance to an embodiment; and

FIG. 9 illustrates a diagram of a print user interface after compiling the configuration parameter rules in accordance to an embodiment.

### DETAILED DESCRIPTION

Aspects of the embodiments disclosed herein relate to methods to configure a print driver in a computer for multiple printing devices, and corresponding apparatus and system for facilitating automatic device driver installation and configuration for a selected device in a managed environment. The disclosed embodiments provide a mechanism for a system administrator (“SA”) to configure a broad range of printer drivers without needing to create multiple configuration packages. The varying tiers allow the SA to fine-tune driver settings for particular printing devices or family of devices while maintaining generally defined pre-configured settings. The printer driver configuration settings are also propagated when the user updates an existing driver to a newer version. The ability to modify the configuration file at any time allows the SA to establish and enforce policy changes for already installed printer drivers. Within a Windows printing environment, the ability to specify the location of the configuration file in a “well-known location” enables customers to configure the driver without breaking its digital signature.

The disclosed embodiments include a method to configure a print driver in a computer for multiple printing devices in a network environment by creating a memory structure containing configuration parameter rules for at least one printing device; and in response to the computer being commanded to utilize the print driver for the at least one printing device, configuring the print driver according to the configuration parameter rules in the memory structure.

In still another aspect the disclosed embodiment a method to configure a print driver wherein the configuration parameter rules in the created memory structure comprise rules with at least one target printer driver attribute, feature attribute, behavior attribute, feature value attribute.

In still another aspect the disclosed embodiment is to a method to configure a print driver wherein the target printer driver attribute is selected from a group consisting of specific print queue, specific print driver, specific printer model, specific printer, specific printer family, all print drivers.

In still another aspect the disclosed embodiment is to a method to configure a print driver wherein the behavior attribute is selected from a group consisting of default value, enforced default value, feature value lock, and feature value exclusion.

In still another aspect the disclosed embodiment is to a method to configure a print driver wherein configuring the print driver is selecting configuration parameter rules in accordance to a set of priorities.

In still another aspect the disclosed embodiment is to a method to configure a print driver further comprising establishing an interval for retrieving the configuration parameter rules from the create memory structure.

In still another aspect the disclosed embodiment is to a method to configure a print driver further comprising using a user interface to set any of the configuration parameter rules in the created memory structure.

In still another aspect the disclosed embodiment is to a method to configure a print driver further comprising saving the configuration parameter rules in a default location of the network environment.

The disclosed embodiments include a system for configuring print drivers for a client in a networked printing environment comprising a memory for storing configuration parameter rules for multiple printing devices; and a processor in communication with a storage medium and the memory, the processor executing machine readable instructions for performing the method of: in response to the client being commanded to utilize the print driver for a printing device reading the configuration parameter rules in the memory; configuring the print driver according to the read configuration parameter rules.

The disclosed embodiments include a system for facilitating automatic device driver installation and configuration for a selected device in a managed environment comprising a network service provider for maintaining and organizing configuration parameter rules and basic drivers for devices installed in the managed environment, the configuration parameter rules sufficient to configure the basic drivers for each of the devices; and a processor to automatically select, install, and to configure an appropriate one of the basic drivers on a computer based on the selected device and the configuration parameter rules.

The term “print engine” as used herein refers to a digital copier or printer, scanner, image printing machine, digital production press, print queue, document processing system, processor, image reproduction machine, bookmaking machine, facsimile machine, multi-function machine, or the like and can include several marking engines, feed mechanism, scanning assembly as well as other print media processing units, such as paper feeders, finishers, and the like.

The term “management information base” (MIB) as used herein refers to a management information block, storage device, and can include any type of network management information and need not be a specific file, format, data structure or design. The MIB is at a minimum adapted to use Simple Network Management Protocol (SNMP).

The term “print media” generally refers to a usually flexible, sometimes curled, physical sheet of paper, plastic, or other suitable physical print media substrate for images, whether precut or web fed.

A “print management station” refers to a monitoring device or computer that is operated by a human user such as a system administrator (SA).

A “target device” is a managed node, such as a printer, computer, print engine, scanner, and the like, that is linked to a computer network.

A “Client” refers to any computational device that is able to send print jobs to a printer. Client devices include, for example a personal computer, workstations, processing systems such as servers, distributed processors, computing clusters, and the like, that execute programs that generate data to be sent to a printer. Such systems are capable of hosting, for instance, databases, application, document generation systems, and any suitable processing able to generate data.

A “Print Server” refers to a processing device that hosts queues for network connected print engines. Print servers can be stand alone processors or exist as one or more processes resident on a server or in a client functioning as a server. Print servers are generally accessible by clients and provide print driver packages to clients in order to support establishing print queues on the client device.

A “Server Print Queue” refers to a print queue that is installed on a print server. Server print queues generally maintain and update queue configuration and status information that is distributed to client print queues.

A “Client Print Queue” refers to a queue that is created on a client device to use a stand alone print engine or network connected print engine. A client print queue is created in conjunction with a print driver for a given print engine that is the destination of the client print queue. A client print queue accepts data sent to an associated networked printer and manages the transmission of the data to that device to implement the printing of the data. Client print queues receive configuration and status information from a server print queue and receive configuration data in the form of a configuration file from a default location.

An “Enterprise” refers to an organization or other entity for which client devices are centrally administered. An enterprise includes, for example, a corporation, association of individuals, or an association of devices that share a mutually accessible data communications network.

An “Enterprise Accessible Location” refers to a data storage location that is accessible by a client connected to a communications network of an enterprise. An example enterprise accessible location is a shared network directory.

A “Default Location” refers to a default enterprise accessible location, client, or to devices tethered to a client such as flash drives and external hard disk drives (“hdd”). An example default location would be, for instance, the location given by: “h:\system\printer\”.

A “Configuration Parameter” refers to at least one setting for the configuration of a print engine. Example configuration parameters include, for example, settings for single-sided printing, duplex mode, color or monochrome, stapling multiple page printouts, stapled or not stapled, paper size, watermark, paper tray, print resolution, and color printing or black and white printing and the like.

A “Configuration File” (or “Config File”) is one or more files with data containing configuration parameters specific for one or more print driver associated with a print engine or print queue. Configuration files are able to be located at a client, at a network accessible location, or at a hosted location in the World Wide Web (WWW).

A print engine “default setting” in the disclosed embodiments, refers to one or more settings that are saved as a default setting to be automatically used for printing unless manually changed at the time of printing.

An “application” refers to a program designed for end users of a computing device, such as a word processing program, a database program, a browser program, a spreadsheet program, a gaming program, and the like. An application is distinct from systems programs, which are low-level programs that interact with the computing device at a very basic level, such as an operating system program, a compiler program, a debugger program, programs for managing computer resources, and the like.

A computational device may be embodied within devices such as a desktop computer, a laptop computer, a handheld computer, a handheld communication device, or another type of computing device, or the like. A computational device has at a minimum a memory, a processor, input/output devices such as a display or a communication interface, and an operator interface for a user to interact with the computational device. The Processor may include at least one conventional processor or microprocessor that interprets and executes instructions. The memory may be a random access memory (RAM) or another type of dynamic storage device that stores information and instructions for execution by the processor. Memory may also include a read-only memory (ROM) which may include a conventional ROM device or another type of static storage device that stores static information and instructions for the processor. The Input/output devices (I/O devices) may include one or more conventional input mechanisms that permit a user to input information to the computational device, such as a microphone, touchpad, keypad, keyboard, mouse, pen, stylus, voice recognition device, buttons, and the like, and output mechanisms such as one or more conventional mechanisms that output information to the user, including a display, one or more speakers, a storage medium, such as a memory, magnetic or optical disk, disk drive, a printer device, and the like, and/or interfaces for the above. The display may typically be an LCD or CRT display as used on many conventional computing devices, or any other type of display device.

The memory may store instructions that may be executed by the processor to perform various functions. For example, the memory may store a printer driver configuration management utility that allows establishing settings for multiple printer drivers and multiple printing devices with a single multi-tiered configuration file, and instructions to automatically select, install, and to configure an appropriate one of basic drivers on a computer based on the selected device and the configuration parameter rules.

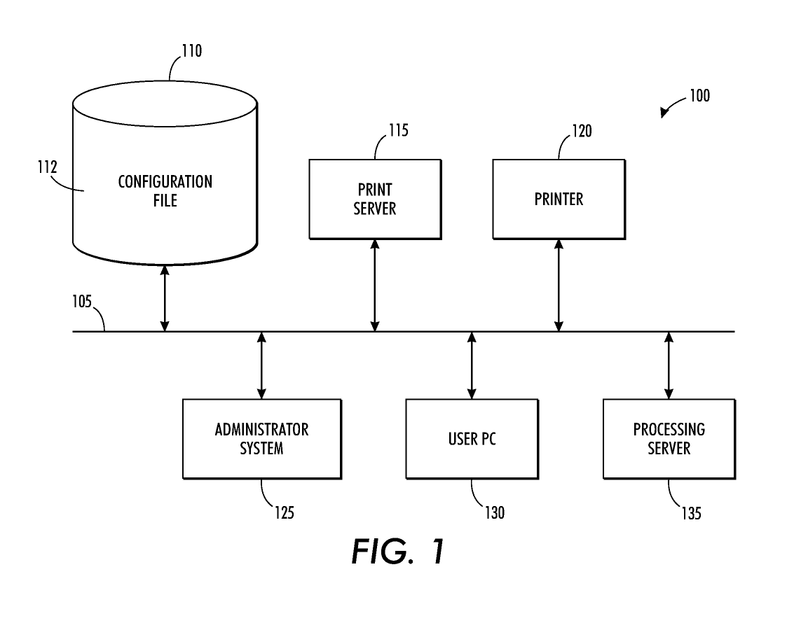

FIG. 1 is an illustration of a networked printing environment 100 in accordance to an embodiment. The networked printing environment 100 shows the devices connected by a communications network 105 that provides a data communications network among various computing resources such as client devices such as User PC 130, processing server 135, and print server 115. The processing server 135 includes, for instance, a server that hosts one or more operational programs, including databases, accounting systems, and the like. The User PC 130 can be a conventional personal computer able to install one or more print drivers. Central data storage 110 is located in an enterprise accessible location and stores at least one printer configuration file 112. The enterprise accessible location can be the default location for a client in order to maintain a local copy of the configuration file. In one embodiment, the central data storage 110 stores at least one printer configuration file or printer configuration data that is accessed by all computers using printers on a network and the configuration data is applied by the print drivers on all computers to ensure an enterprise-wide printer configurations.

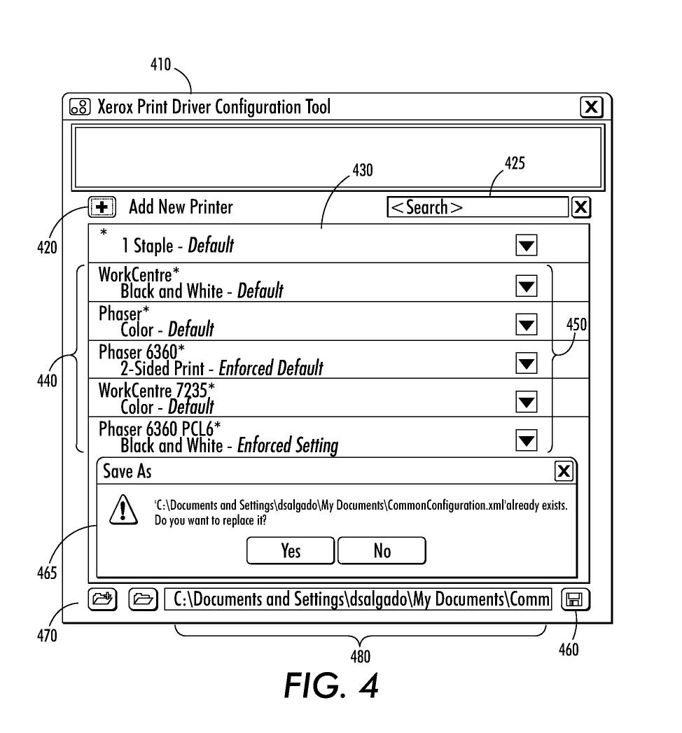

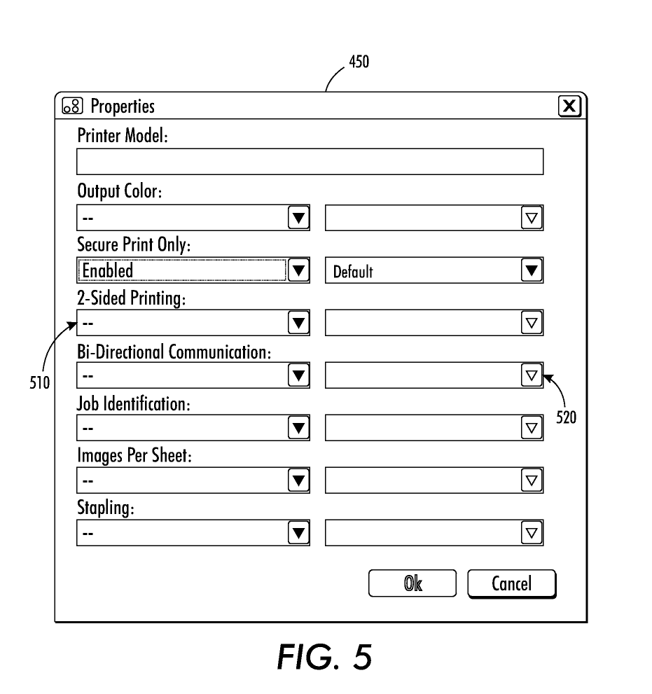

An administrator system 125 or print management station is used by administrators (SA) to create or modify a printer configuration file. The SA uses a printer driver configuration management utility, described in FIG. 4 and FIG. 5, which allows the SA to establish parameters or settings for multiple printer drivers and multiple printing devices with a single multi-tiered configuration file. A single multi-tiered configuration file makes it possible to pre-configure and post-configure multiple printer drivers at a one sitting. Each setting may have rules of behavior such as a default value, enforced default value, value setting lock and disallowance of a value. The print drivers installed are able to be automatically configured, through configuration of print servers associated with respective printers, to conform to the printing defaults specified in the printer configuration file stored in the central data storage 110 or default location. As shown the location of the central data storage is a UNC network path. However the SA is able to specify, for folder on a client example, a local device, such as a temporary folder, a user profile, or the like. The central data storage is referred to as a memory structure that is located in a network, a client, or embodied in a disk that when compiled by a processor creates a configuration file in a computing device.

The printer driver configuration management utility may further allow the administrator to specify an interval at which devices such as clients are to access the central data storage to determine if an update to the configuration file exists. In a preferred embodiment, the User PC 130 initiates the update method each time it is powered up, and may further initiate the update method after selected intervals of time, e.g., once every twelve hours while it remains powered up. However, those skilled in the art will recognize, after perusal of this application, that there are no specific times when the update method must be initiated, and that selection of various times for initiation of the method are within the scope and spirit of the invention. Regardless of when the updates are initiated the client queries the central data storage and applies any changes made to the configuration file to the print driver for the selected printing device.

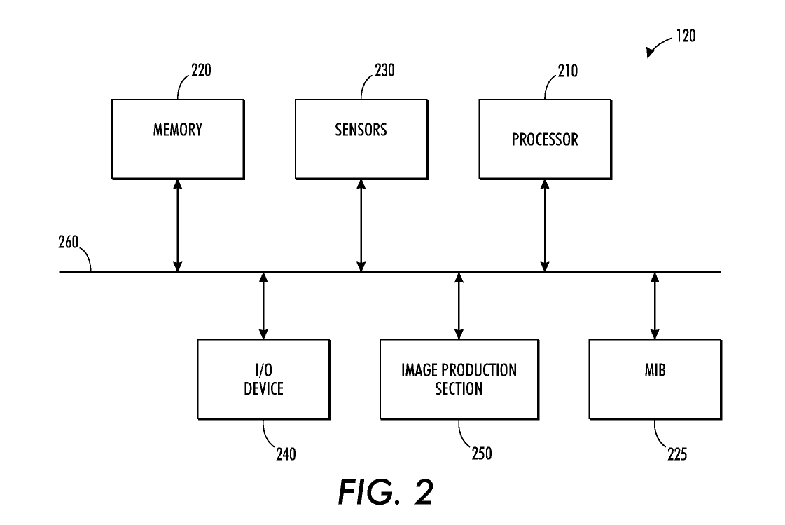

FIG. 2 illustrates a block diagram of a controller for printer system 120 in accordance to an embodiment. The controller may be embodied within devices such as a desktop computer, a laptop computer, or another type of computing or electronic device, or the like. The controller may include a memory 220, a processor 210, input/output devices 240, image reproduction section 250 and a bus 260. The bus 260 may permit communication and transfer of signals among the components of the computing device such as processor 210.

Processor 210 may include at least one conventional processor or microprocessor that interprets and executes instructions. Memory 220 may be a random access memory (RAM) or another type of dynamic storage device that stores information and instructions for execution by processor 210. Memory 220 may also include a read-only memory (ROM) which may include a conventional ROM device or another type of static storage device that stores static information and instructions for processor 210. Input/output devices 240 (I/O devices) may include one or more conventional input mechanisms that permit a user to input information to the controller, such as a microphone, touchpad, keypad , keyboard, mouse, pen, stylus, voice recognition device, buttons, and the like, and output mechanisms such as one or more conventional mechanisms that output information to the user, including a display, one or more speakers, a storage medium, such as a memory, magnetic or optical disk, disk drive, a printer device, and the like, and/or interfaces for the above. Image production section 250, which includes hardware by which image signals are used to create a desired image for processing at the target device such as a printer. The sensors 230 can be real sensors distributed throughout the print engine and/or virtual sensors, distributed throughout software modules of the print engine) and/or controller. The information from sensors 150 is delivered to MIB 225. The controller may perform functions in response to processor 210 by executing sequences of instructions or instruction sets contained in a computer-readable medium, such as, for example, memory 220. Such instructions may be read into memory 220 from another computer-readable medium, such as a storage device, or from a separate device via a communication interface, or may be downloaded from an external source such as the Internet. While described with respect to a printing engine it should be understood that components such as the processor 210, memory 220, I/O devices 240 are applicable can be used in other devices like as client or as a print server with the appropriate instructions. The memory 220 may store instructions that may be executed by the processor to perform various functions. For example, the memory may store instructions to allow the controller to perform various printing functions in association with a particular printing engine connected to the controller.

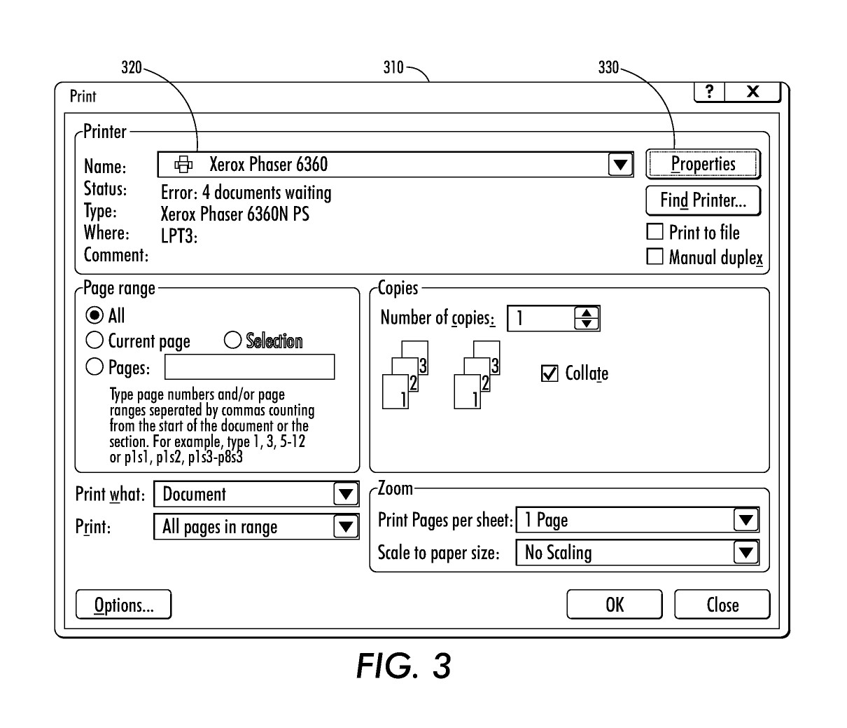

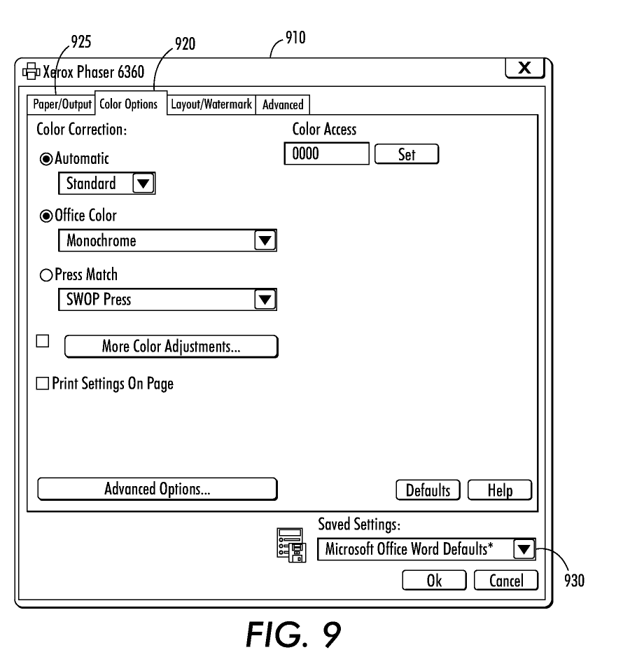

FIG. 3 illustrates a diagram of a print user interface 310 in accordance to an embodiment. The printer user interface 310 may be displayed on a display of a computer such as User PC 130. The printer user interface 310 may be invoked and displayed when a user selects a print function on the computer typically using an input device such as a keyboard, for example. The user may typically select a printer in the printer selection area 320 through the use of a drop-down menu. The user will typically be able to select from all printers for which a print driver has been loaded into memory of User PC 130. Upon selection of properties 330, a further printer user interface 910 (FIG. 9) will be displayed showing paper and color options. The print user interfaces 310, 910 are example interfaces, and other print user interfaces may be used.

FIG. 4 illustrates the user interface 410 for a print driver configuration tool in accordance to an embodiment. A system administrator (SA) invokes the interface 410 for the print driver configuration tool at a client device like administrator system 125. Using the interface 410 the SA is able to create a configuration file with configuration parameters for print drivers. The SA can assign a configuration rule to a printer through the “add new printer” option 420. Here the SA will be given a choice of all known printers from a database of known printers, selection of those printers that are connected to the network 105, to write the name of a printer, or to designate the rule as being applicable to all print drivers for a particular print engine or printer from a particular manufacturer through the use of a wild character such as the asterisk (“*”). For example, all WorkCentre printer drivers or all Phaser 6360 printer drivers. The wild character can also be used to designate a specific printer manufacturer like all Xerox printer drivers by using “Xerox *”. The SA may also search for the name of a printer by using search bar 425. The selected print engine can be assigned a rule like attribute 430 which defaults all printers to “1 staple”. The relationship of rules, priorities, and capabilities of the print engine is discussed below. The SA can select a group, all print engines (using a wild character), a family of print engines, or specific printers as shown with reference to target printer driver attribute 440. The SA can select parameters 450 for the target printer driver attribute which is discussed in details below in FIG. 5. The print driver configuration tool gives the SA the opportunity to save 460 the settings to a default location 480. The SA can change the default location by selecting another location through an appropriate control mechanism like the select directory icon 470. The print driver configuration tool provides the SA with the choice of replacing or renaming the configuration file through a message box window 465. The SA can select to save one or more configuration file in the default location. The saved configuration files are then compiled individually and their rules applied to the print driver for the print engine.

FIG. 5 illustrates a diagram of a print driver configuration tool properties interface in accordance to an embodiment. Upon selection of add a new printer 420, a further print driver configuration tool interface will be displayed, as illustrated herein. The interface allows the SA to specify a printer model 450 for which to create rules that will become part of the print driver. The SA can select feature attributes 510 such as output color, secure print only, 2-sided printing, bi-directional communication, job identification, and images per sheet, stapling, and other feature attributes. The SA can then assign behavior and a feature value 520 to a selected feature attribute.

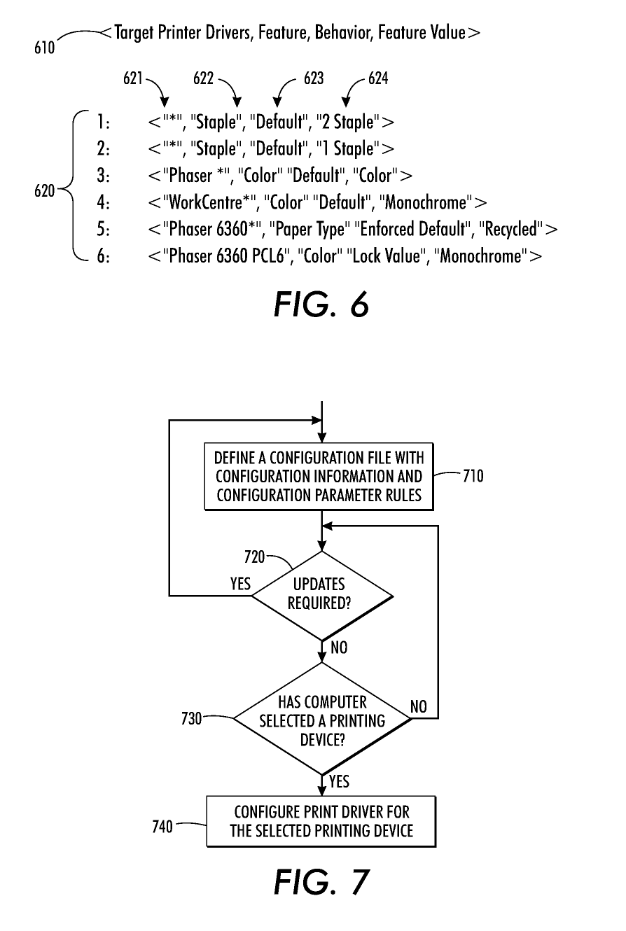

FIG. 6 is an illustration of the format for a print driver configuration rule in accordance to an embodiment. The format 610 of each configuration setting is <Target Printer Drivers, Feature, Behavior, Feature Value> where set of Behaviors include the ability to 1) specify a default value, 2) specify an enforced default value where the user can't modify the default after installation, 3) lock a feature to a value, and 4) disallow a value for a feature. An SA created configuration file is shown with six (6) rules 620. The target printer driver attribute 621 indicates that the first rule is applicable to all print engines. A glyph such as an asterisk is used to denote all print engines or all print engines grouped according to an attribute (manufacturer, color, paper size, or user defined) and the like. The glyph would potentially make the rule applicable to all devices that are so designated. Other symbols or designations could be used to indicate all devices. In the shown six rules 620, the first rule concerns the “staple” feature 622. The behavior 623 of the feature 622 is to be set as default. The feature value 624 is set at “2 staple”. Further note that rule 2 of the configuration file appears to indicate that “1 staple” is the default value for all printers. When a client compiles the rules it follows a certain priority and capability sequence for the given printing device. Rule 1 trumps rule 2 because it appears first in the configuration file; however rule 2 would trump rule 1 if the selected printing engine does not have the feature as an option. From the configuration file consisting of six rules 620, it can be seen that the two Phaser devices only have finishers that can 1-Staple, while the WorkCentre can 2-Staple. All 3 products are color devices. When the user opens the Phaser 6360 PCL6 driver rules 2, 5, and 6 are executed. Rule 1 is ignored since the Phaser 6360 PCL6 can't “2-staple”. Rule 3 is ignored since it is lower priority than rule 6. Further, rule 4 is not considered because it is rule applicable only to WorkCentre type of printer. On the print user interface, see FIG. 9, the user sees Staple defaulted to 1-Staple, Paper Type strictly defaulted to “Recycled”, and Color locked to Monochrome. When the user opens the WorkCentre Pro 7655 driver rule 1 and rule 4 are executed. Rule 2 is skipped since 1 appears first in the file. The user sees Staple defaulted to 2-Staple and Color defaulted to Monochrome. When multiple files exist, the printer driver reads all the rules from the multiple files prior to executing the rules giving the SA the ability to replace or add a configuration file independent of the installed printer drivers. All installed printer drivers will execute the rules in the updated configuration file instead of the prior configuration file.

The system administrator is able to assign priorities or tiers to the rules in the configuration file. The settings for the print drivers in the illustrated configuration file have tier rule priority, such as (highest to lowest) 1. Print queue, “Phaser 6360 Green Printing”; 2. Printer driver, “Phaser 6360DX PS”; 3. Printer model, “Phaser 6360DX *”; 4. All printer models, “Phaser 6360DX *”; 5. Printer family, “Phaser *”; and 6. All drivers “*”. As such, the more exact and well-defined the Target Printer Drivers is; the higher the priority of the rule.

FIG. 7 illustrates a flowchart of a method 700 to configure a print driver in a computer for multiple printing devices in a network environment in accordance to an environment. Method 700 begins with action 710 where the computing device such as User PC 130 defines a configuration file with configuration parameters (settings) and configuration parameter rules (priorities and the like) are define in an appropriate memory structure. In one embodiment, the client loads the configuration file from a default location to the random access memory (RAM) for processing of a print request. Control is passed to action 720 for further processing. In action 720 the computing device determines if the configuration file needs to be updated. If the determination id “YES” then control is passed to a module that performs the updates in accordance to a predetermined schedule. When the determination in action 720 is “NO” control is passed to action 730 for further processing. In action 730 the computing device tries to ascertain if the request came with a selected printing device. Normally the printer user interface, like printer interface 310 in FIG. 3, has a default printer device selected and action 730 would not be necessary. If action 730 determines that a printing device has not been selected then control is returned to action 720 for further processing. The user is given the opportunity to select a printing device. If action 730 determines that a printing device has been selected control is passed to action 740 for processing. In action 740 the computing device compiles the configuration file that comprise rules with at least one target printer driver attribute, feature attribute, behavior attribute, feature value attribute to configure the print driver for the selected printing device.

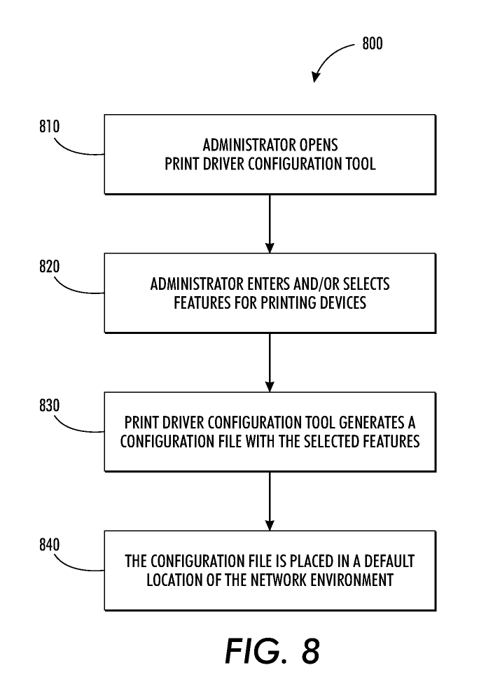

FIG. 8 illustrates a flowchart of a method 800 to create configuration parameter rules in accordance to an embodiment. The administrator (SA) opens the driver configuration protocol in action 810 at a computing device like administrator system 125 in FIG. 1. In action 820 the SA enters and/or selects features or settings for printing devices. The setting may have rules of behavior such as a default value, enforced default value, value setting lock and disallowance of a value as explained above with reference to FIG. 6. In action 830, the print driver configuration tool generates a configuration file the selected features or settings. As noted earlier the format of the generated configuration file consists of attributes relating to: <Target Printer Drivers, Feature, Behavior, Feature Value>. The set of Behaviors include the ability to 1) specify a default value, 2) specify an enforced default value (where the user can't modify the default after installation), 3) lock a feature to a value, and 4) disallow a value for a feature. In action 840 the configuration file generated in action 830 is placed in a default location of the network, client in the network, or in a computer readable medium. The default location of the configuration file is a central data storage 110 that is accessible by a network 105, including wide area networking facilities, by any client device utilizing a printer connected to the network.

FIG. 9 illustrates a diagram of a print user interface after compiling the configuration parameter rules in accordance to an embodiment. The printer user interface 910 is illustrated with the color options document setting selected by the rules in the configuration file, and with office color selected to black and white (Monochrome). Additionally, the default application setting 930 has been selected as a Microsoft Office Word Default. The dropdown menu would allow saving this setting in other ways, such as a driver default (not specific to any application), under a default name selected by a user, or for another application. The print drivers as described herein may provide the user with a printer user interface that gives the user a choice of saving printer document settings as a default application setting of the specific application the user is using at that time. Thus, if the user is in Internet Explorer. Alternatively, the drop-down list may include a list of plural application defaults that the user may choose from, and more than one application default could be saved at the same time. The paper output features 925 can also be viewed by the user.

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method to configure a print driver in a computer for multiple printing devices in a network environment, the method comprising:
creating a memory structure containing configuration parameter rules for at least one printing device; and
in response to the computer being commanded to utilize the print driver for the at least one printing device, configuring the print driver according to the configuration parameter rules in the memory structure.

2. The method according to claim 1, wherein the configuration parameter rules in the created memory structure comprise rules with at least one target printer driver attribute, feature attribute, behavior attribute, feature value attribute.

3. The method according to claim 2, wherein the target printer driver attribute is selected from a group consisting of specific print queue, specific print driver, specific printer model, specific printer, specific printer family, specific printer manufacturer, all print engines.

4. The method according to claim 3, wherein the behavior attribute is selected from a group consisting of default value, enforced default value, feature value lock, and feature value exclusion.

5. The method according to claim 3, wherein configuring the print driver is selecting configuration parameter rules in accordance to a set of priorities.

6. The method according to claim 2, further comprising establishing an interval for retrieving the configuration parameter rules from the create memory structure.

7. The method according to claim 6, further comprising using a user interface to set any of the configuration parameter rules in the created memory structure.

8. The method according to claim 7, further comprising saving the configuration parameter rules in a default location of the network environment.

9. A system for configuring print drivers for a client in a networked printing environment, the system comprising:
a memory for storing configuration parameter rules for multiple printing devices; and
a processor in communication with a storage medium and the memory, the processor executing machine readable instructions for performing the method of:
in response to the client being commanded to utilize the print driver for a printing device reading the configuration parameter rules in the memory;
configuring the print driver according to the read configuration parameter rules.

10. The system according to claim 9, wherein the configuration parameter rules in the memory comprise rules with at least one target printer driver attribute, feature attribute, behavior attribute, feature value attribute.

11. The system according to claim 10, wherein the target printer driver attribute is selected from a group consisting of specific print queue, specific print driver, specific printer model, specific printer, specific printer family, specific printer manufacturer, all print engines.

12. The system according to claim 11, wherein the behavior attribute is selected from a group consisting of default value, enforced default value, feature value lock, and feature value exclusion.

13. The system according to claim 11, wherein configuring the print driver is selecting configuration parameter rules in accordance to a set of priorities.

14. The system according to claim 10, further comprising establishing an interval for retrieving the configuration parameter rules from the memory.

15. The system according to claim 14, further comprising using a user interface to set any of the configuration parameter rules in the memory.

16. The system according to claim 15, further comprising saving the configuration parameter rules in a default location of the network printing environment.

17. A system for facilitating automatic device driver installation and configuration for a selected device in a managed environment comprising:
a network service provider for maintaining and organizing configuration parameter rules and basic drivers for devices installed in the managed environment, the configuration parameter rules sufficient to configure the basic drivers for each of the devices; and
a processor to automatically select, install, and to configure an appropriate one of the basic drivers on a computer based on the selected device and the configuration parameter rules.

18. The system according to claim 17, wherein the configuration parameter rules in the network service provider comprise rules with at least one target printer driver attribute, feature attribute, behavior attribute, feature value attribute.

19. The system according to claim 18, wherein the target printer driver attribute is selected from a group consisting of specific print queue, specific print driver, specific printer model, specific printer, specific printer family, specific printer manufacturer, all print engines.

20. The system according to claim 19, wherein the behavior attribute is selected from a group consisting of default value, enforced default value, feature value lock, and feature value exclusion.

21. The system according to claim 19, wherein configuring the print driver is selecting configuration parameter rules in accordance to a set of priorities.

22. The system according to claim 18, further comprising establishing an interval for retrieving the configuration parameter rules from the network service provider.

23. The system according to claim 22, further comprising using a user interface to set any of the configuration parameter rules in the network service provider.

24. The system according to claim 23, further comprising saving the configuration parameter rules in a default location of the computer.
